(19) United States
(12) Patent Application Publication
(10) Pub. No.: US 2014/0292585 A1
(43) Pub. Date: Oct. 2, 2014

(54) ANTENNA AND WIRELESS COMMUNICATION DEVICE

(71) Applicant: MURATA MANUFACTURING CO., LTD., Kyoto (JP)

(72) Inventors: Kunihiro KOMAKI, Kyoto (JP); Chiharu MINAMI, Kyoto (JP)

(73) Assignee: MURATA MANUFACTURING CO., LTD., Kyoto (JP)

(21) Appl. No.: 14/301,617

(22) Filed: Jun. 11, 2014

Related U.S. Application Data
(63) Continuation of application No. PCT/JP2013/065318, filed on Jun. 3, 2013.

(30) Foreign Application Priority Data
Jun. 8, 2012 (JP) 2012-130975

(51) Int. Cl. H01Q 1/38

(52) U.S. Cl. CPC H01Q 1/38
USPC 343/700 MS

(57) ABSTRACT

An antenna includes a dielectric base and a radiation electrode formed in the surface of the dielectric base. The radiation electrode includes a side surface electrode formed in the side surface of the dielectric base and a top surface electrode formed in the top surface of the dielectric base. A first point and a second point in the middle of an electrical length leading from a power feeding end of the radiation electrode to an open end are adjacent to each other, and in this adjacent portion, capacitance is formed between the first point and the second point. In addition, a third point and a fourth point in the middle of an electrical length are adjacent to each other, and in this adjacent portion, capacitance is formed between the third point and the fourth point.

### CROSS REFERENCE

This application claims benefit of priority to Japanese Patent Application No. 2012-130975 filed Jun. 8, 2012, and to International Patent Application No. PCT/JP2013/065318 filed on Jun. 3, 2013, the entire content of each of which are incorporated herein by reference.

### TECHNICAL FIELD

The present technical field relates to a small antenna used for, for example, a mobile communication device such as a cellular phone terminal or a GPS receiver or an electronic device having a short distance wireless communication function such as Bluetooth (registered trademark)wireless technology, and a wireless communication device equipped with that antenna.

### BACKGROUND

For example, in Japanese Unexamined Patent Application Publication No. 2002-158529, an antenna has been disclosed that has achieved a wider bandwidth and multiband functionality. FIG. 4 is the perspective view of an antenna disclosed in Japanese Unexamined Patent Application Publication No. 2002-158529. This antenna 1 includes a dielectric base 2, a loop-shaped radiation electrode 3 formed in the corresponding base 2, and a feeding electrode 4. From the feeding electrode 4, the above-mentioned loop-shaped radiation electrode 3 is formed in a loop shape along the individual sides of a rectangle-shaped top surface. The open end 3a of this loop-shaped radiation electrode 3 is disposed so as to face a projecting electrode portion 18 in a power feeding end-side electrode part across a distance, and capacitance is formed between the corresponding open end 3a and the power feeding end-side electrode part.

### SUMMARY

### Technical Problem

In an antenna including a radiation electrode having such a shape as illustrated in FIG. 4, the open end of the radiation electrode and the vicinity of a power feeding portion are adjacent to each other, and capacitance is formed. In addition, owing to this capacitance, it may be possible to set the resonant frequency of a high-order mode while rarely influencing the resonant frequency of a fundamental mode.

However, in the antenna illustrated in FIG. 4, since, owing to the capacitance formed between the open end of the radiation electrode and the power feeding portion, the frequency of the high-order mode is controlled. It is difficult to control a high-order mode higher than this high-order mode or another fundamental mode. Therefore, it is difficult to configure an antenna operating in two modes or more. In addition, since the capacitance formed between the open end of the radiation electrode and the power feeding portion suppresses the radiation of the fundamental mode, there is a problem that the radiation characteristic of the fundamental mode is deteriorated.

It is an object of the present disclosure to provide an antenna having a multiband capability without deteriorating the radiation characteristic of the fundamental mode, and a wireless communication device equipped with that antenna.

### Solution to Problem

An antenna device of the present disclosure includes a dielectric base, and a radiation electrode formed in the dielectric base, wherein a first point and a second point are adjacent to each other. The first point being a position at a first electrical length from a power feeding end of the radiation electrode, in an electrical length leading from the power feeding end to an open end of the radiation electrode. The second point being a position at an electrical length of about ½ of the first electrical length from the first point in a direction of the open end. Capacitance is formed between the first point and the second point.

Owing to the above-mentioned configuration, a resonant mode occurs in which the first point serves as an equivalent short-circuited end and the second point serves as an equivalent open end. Since this resonant mode is a mode utilizing not the whole of the radiation electrode but a portion of the radiation electrode, resonance occurs with a frequency higher than a fundamental mode utilizing the whole of the radiation electrode. In addition, the control of a high-order mode is performed not by capacitance formed between the open end of the radiation electrode and a power feeding portion but by capacitance formed between the vicinity of the open end and a point serving as a subsequent current maximum point viewed from the open end, and hence, it may be possible to prevent the radiation efficiency of the fundamental mode from being deteriorated.

It is desirable that a third point and a fourth point are adjacent to each other. The third point being a position at a second electrical length from the power feeding end of the radiation electrode, in the electrical length leading from the power feeding end to the open end of the radiation electrode. The fourth point being a position at an electrical length of about ½ of the second electrical length from the third point in the direction of the open end. Capacitance is formed between the third point and the fourth point. Owing to this configuration, a function as a multiband antenna occurs, the multiband antenna resonating in the resonant modes of three bands or more.

It is desirable that the dielectric base is a compact of a dielectric composite resin material in which a dielectric ceramic filler is distributed within a resin material. Owing to this, it may be possible to form an arbitrary shape corresponding to the shape of the chassis of a device incorporated therein.

A wireless communication device of the present disclosure includes an antenna having the above-mentioned configuration, and a communication circuit connected to the antenna, wherein the communication circuit is configured in a substrate, and the antenna is connected to the substrate.

### Advantageous Effects of Disclosure

According to the present disclosure, the resonances of a fundamental mode utilizing the whole of a radiation electrode and a high-order mode utilizing a portion of the radiation electrode occur, and function as a multiband antenna. Furthermore, the control of the high-order mode is performed not by capacitance formed between the open end of the radiation electrode and a power feeding portion but by capacitance formed between the vicinity of the open end and a point serving as a subsequent current maximum point viewed from the open end. The radiation efficiency of the fundamental mode is not deteriorated.

### BRIEF DESCRIPTION OF THE DRAWINGS

FIG. 1 is a perspective view of an antenna device according to a first embodiment.

FIG. 2(A), FIG. 2(B), and FIG. 2(C) are diagrams illustrating electric field intensity distributions of individual resonant modes on a radiation electrode.

FIG. 3 is a perspective view of an antenna device according to a second embodiment.

FIG. 4 is a perspective view of a surface-mounted antenna disclosed in Japanese Unexamined Patent Application Publication No. 2002-158529.

### DETAILED DESCRIPTION

### First Embodiment

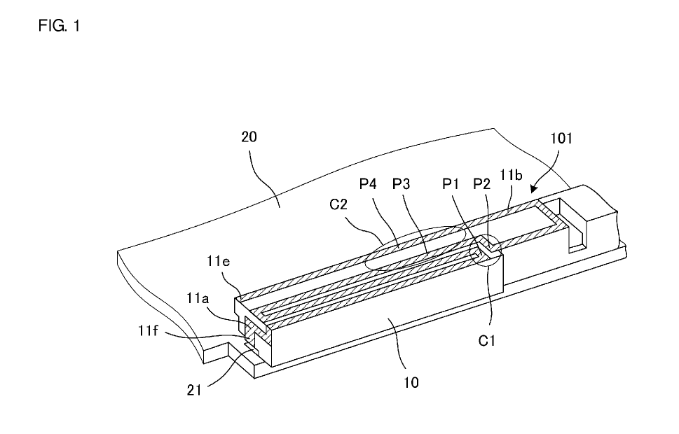

FIG. 1 is a perspective view of an antenna device according to a first embodiment. This antenna device includes a substrate 20 and an antenna 101 integrated with a chassis. The antenna 101 includes a dielectric base 10 and a radiation electrode formed in the surface of this dielectric base 10. The dielectric base 10 is a compact form of a dielectric composite resin material in which a dielectric ceramic filler is distributed within a resin material. The radiation electrode includes a side surface electrode 11a formed in the side surface of the dielectric base 10, and a top surface electrode 11b formed in the top surface of the dielectric base 10. One end portion of the radiation electrode is a power feeding end 11f, and the other end portion thereof is an open end 11e.

In the middle of an electrical length leading from the power feeding end 11f of the radiation electrode to the open end 11e thereof, a first point P1 and a second point P2 are adjacent to each other. The first point P1 is at a position at a first electrical length from the power feeding end 11f, in the electrical length leading from the power feeding end 11f of the radiation electrode to the open end 11e thereof. The second point P2 is at a position at a second electrical length from the power feeding end 11f. This second point P2 is at a position at the electrical length of about ½ of the first electrical length from the first point P1 in an open end 11e direction.

In an adjacent portion (first capacitance forming portion C1) of the first point P1 and the second point P2, capacitance is formed between the first point P1 and the second point P2.

In addition, in the middle of the electrical length leading from the power feeding end 11f of the radiation electrode to the open end 11e thereof, a third point P3 and a fourth point P4 are adjacent to each other. The third point P3 is at a position at a third electrical length from the power feeding end 11f, in the electrical length leading from the power feeding end 11f of the radiation electrode to the open end 11e thereof. The fourth point P4 is at a position at a fourth electrical length from the power feeding end 11f. This fourth point P4 is at a position at the electrical length of about ½ of the third electrical length from the third point P3 in the open end 11e direction.

In an adjacent portion (second capacitance forming portion C2) of the third point P3 and the fourth point P4, capacitance is formed between the third point P3 and the fourth point P4.

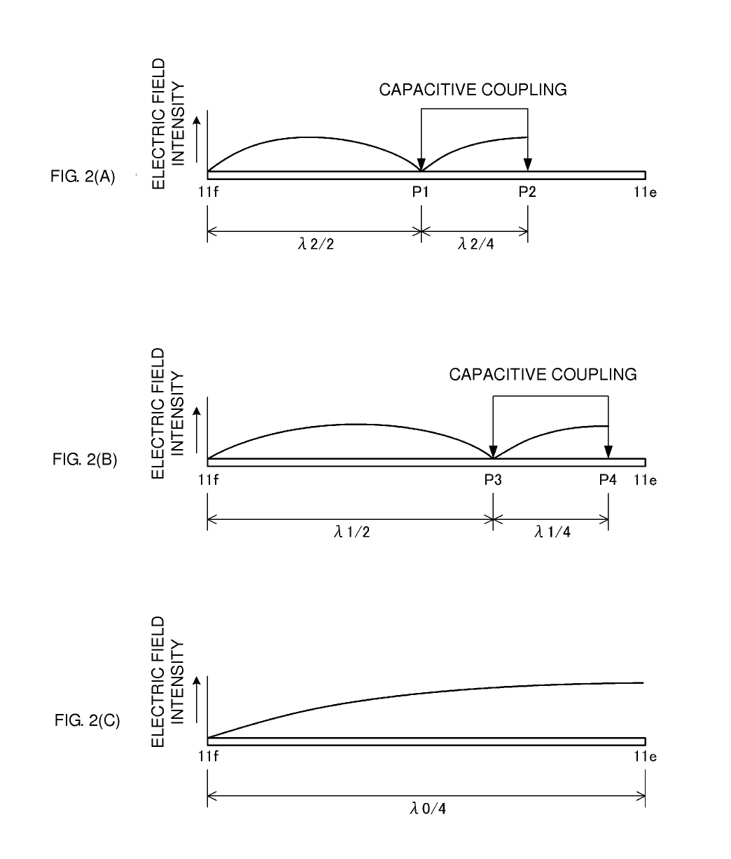

FIG. 2(A), FIG. 2(B), and FIG. 2(C) are diagrams illustrating electric field intensity distributions of individual resonant modes on the radiation electrode.

FIG. 2(A) illustrates the electric field intensity distribution of a resonant mode in which the first point P1 serves as an equivalent short-circuited end and the second point P2 serves as an equivalent open end. Since the first point P1 and the second point P2 are capacitively-coupled in the first capacitance forming portion C1, a standing wave of a third-order mode occurs where, in relation to the power feeding end 11f, the first point P1 is the node of a ½wavelength and the second point P2 is the antinode of a ¾wavelength. When being expressed using a current density distribution, the power feeding end 11f and the first point P1 are antinodes, and a center between the power feeding end 11f and the first point P1 and the second point P2 are nodes. λ2 illustrated in FIG. 2(A) is one wavelength of this third-order mode. Owing to the capacitance of the first capacitance forming portion C1, a phase difference between the potential changes of the first point P1 and the second point P2 becomes 90 degrees, and a potential difference becomes large between the first point P1 and the second point P2. Therefore, the first point P1 serves as the node of the ½wavelength of the electric field intensity, and the second point P2 serves as the antinode of the ¾wavelength of the electric field intensity. Owing to this, the second point P2 may be regarded as the equivalent (virtual) open end of the third-order mode, and in this resonant mode, it may be considered that a radiation electrode leading from the second point P2 to the open end 11e does not exist.

Since, in this way, the standing wave of the third-order resonant mode occurs that does not utilize the whole of the radiation electrode but a portion of the radiation electrode, resonance occurs with a frequency different from the resonant mode utilizing the whole of the radiation electrode. This resonant frequency is, for example, a frequency in a 2100 MHz band.

FIG. 2(B) illustrates the electric field intensity distribution of a resonant mode in which the third point P3 serves as an equivalent short-circuited end and the fourth point P4 serves as an equivalent open end. Since the third point P3 and the fourth point P4 are capacitively-coupled in the second capacitance forming portion C2, a standing wave of a third-order mode occurs where, in relation to the power feeding end 11f, the third point P3 is the node of a ½wavelength and the fourth point P4 is the antinode of a ¾wavelength. λ1 illustrated in FIG. 2(B) is one wavelength of this third-order mode. In other words, in the same way as the case illustrated in FIG. 2(A), owing to the capacitance of the second capacitance forming portion C2, a phase difference between the potential changes of the third point P3 and the fourth point P4 becomes 90 degrees, and a potential difference becomes large between the third point P3 and the fourth point P4. Therefore, the third point P3 serves as the node of the ½wavelength of the electric field intensity, and the fourth point P4 serves as the antinode of the ¾wavelength of the electric field intensity. This resonant frequency is, for example, a frequency in a 1800 MHz band.

FIG. 2(C) illustrates the electric field intensity distribution of a fundamental resonant mode in which the power feeding end 11f serves as a short-circuited end and the open end 11e serves as an open end. In this way, a standing wave of the fundamental resonant mode occurs where the open end 11e is the antinode of the ¼wavelength of the electric field intensity. λ0 illustrated in FIG. 2(C) is one wavelength of this fundamental resonant mode. This resonant frequency is, for example, a frequency in a 800 MHz band.

In addition, the positions of the first point P1 and the second point P2 on the radiation electrode are not necessarily caused to be locally adjacent. As illustrated in FIG. 2(A), if the point (P1) and the point (P2) are adjacent to each other, the point (P1) being located a ½wavelength away from the power feeding end 11f where the wavelength is the wavelength of the resonant frequency (in the 2100 MHz band) of an intended third-order mode, the point (P2) being located a ¼wavelength away therefrom where the wavelength is the wavelength of the above-mentioned resonant frequency (in the 2100 MHz band), capacitance occurs between this first point P1 and the second point P2, and capacitive coupling occurs. In other words, if the first point P1 and the second point P2 exist that satisfy the above-mentioned condition, a standing wave occurs at the resonant frequency of the intended third-order mode.

The above-mentioned matter is applied to a positional relationship between the third point P3 and the fourth point P4, in the same way. In the example illustrated in FIG. 1, the positions of the third point P3 and the fourth point P4 exist within ranges adjacent to each other in parallel with each other, in the radiation electrode. The positions of the third point P3 and the fourth point P4 are not arbitrary. A point located a ½wavelength away from the power feeding end 11f is the third point P3, the wavelength being the wavelength of the resonant frequency (in the 1800 MHz band) of the intended third-order mode, and a position located a ¼wavelength away therefrom is the fourth point P4, the wavelength being the wavelength of the above-mentioned resonant frequency (in the 1800 MHz band). In this regard, however, if points corresponding to P3 and P4 exist even at a frequency sifted from the resonant frequency (in the 1800 MHz band) of the intended third-order mode, the standing wave of the third-order mode also occurs at that frequency. Accordingly, the bandwidth of the resonant frequency has a certain width.

As illustrated in FIG. 2(A) and FIG. 2(B), by putting a position (an electric field intensity minimum position) close to a near side (a power feeding end side), compared with the open end 11e, the position being located at the ½wavelength of a standing wave distribution from the power feeding portion in the high-order mode, it may be possible to put the original open end 11e (for the fundamental mode) away from the power feeding portion with controlling the resonant frequency of the high-order mode using the newly configured capacitance forming portions C1 and C2, and it may be possible to suppress the deterioration of the fundamental mode. In other words, a configuration is not adopted in which, as illustrated in FIG. 4, the capacitance is configured by causing the open end of the radiation electrode and the power feeding portion to be adjacent to each other and the resonant frequency is controlled using the capacitance. Therefore, since the open end of the fundamental mode does not come close to the power feeding portion, in other words, the open end does not come close to a ground, and the deterioration of the radiation characteristic of the fundamental mode is not caused.

As illustrated above, a function as an antenna occurs, the antenna having three bands including the 2100 MHz band, the 1800 MHz band, and the 800 MHz band.

In the substrate 20, a communication circuit is configured that is connected to the feeding electrode 21. The antenna 101 is integrated with the chassis of a wireless communication device such as a cellular phone terminal, and in a state where the substrate 20 is incorporated in this chassis, the power feeding end 11f of the radiation electrode is connected to the feeding electrode 21 through a pin terminal. In this way, the wireless communication device is configured.

### Second Embodiment

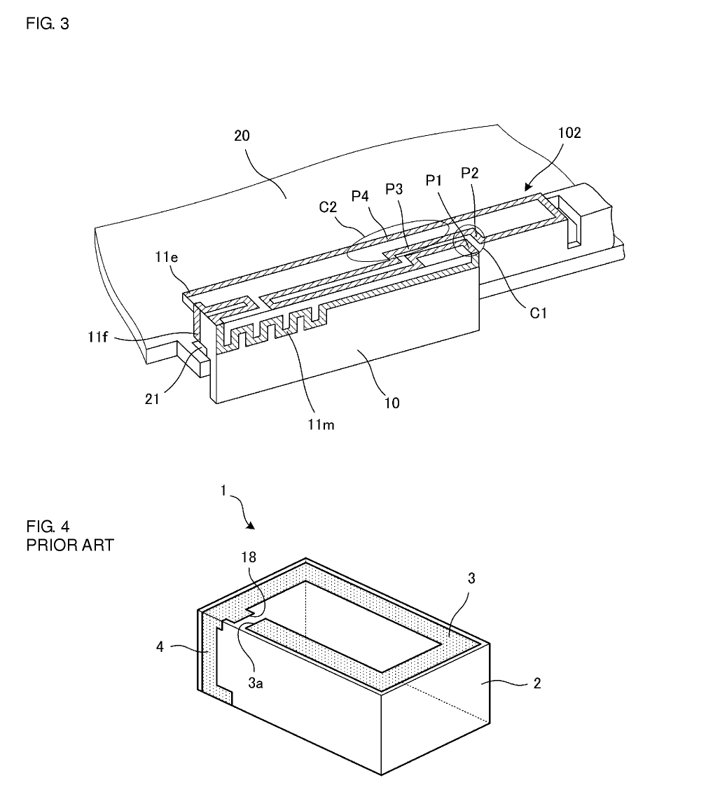

FIG. 3 is the perspective view of an antenna device according to a second embodiment. This antenna device includes a substrate 20 and an antenna 102 integrated with a chassis. The antenna 102 includes a dielectric base 10 and a radiation electrode formed in the surface of this dielectric base 10. One end portion of the radiation electrode is a power feeding end 11f, and the other end portion thereof is an open end 11e.

In the middle of an electrical length leading from the power feeding end 11f of the radiation electrode to the open end 11e thereof, a first point P1 and a second point P2 are adjacent to each other. In an adjacent portion (first capacitance forming portion C1) of the first point P1 and the second point P2, capacitance is formed between the first point P1 and the second point P2.

In addition, in the middle of the electrical length leading from the power feeding end 11f of the radiation electrode to the open end 11e thereof, a third point P3 and a fourth point P4 are adjacent to each other. In an adjacent portion (second capacitance forming portion C2) of the third point P3 and the fourth point P4, capacitance is formed between the third point P3 and the fourth point P4.

The electric positions of the first capacitance forming portion C1 and the second capacitance forming portion C2 on the radiation electrode are the same as those illustrated in the first embodiment. Accordingly, in the same way as the antenna 101 illustrated in the first embodiment, a function as an antenna having three bands occurs.

In the antenna 102 illustrated in FIG. 3, by causing the vicinity of the power feeding end of the radiation electrode to have a meander line shape, an inductance component in the vicinity of the power feeding end increases, and it may be possible to reduce the physical length of the whole radiation electrode. In addition, the third point P3 on the radiation electrode is caused to have a meander line shape, and the third point P3 and the fourth point P4 are caused to be locally adjacent to each other. Therefore, it may be possible to form the second capacitance forming portion C2 in a predetermined local position.

In addition, while, in each of the embodiments illustrated above, the compact of a dielectric composite resin material is used for the dielectric base of the antenna, dielectric ceramics may also be used as the dielectric base, and a chip antenna may also be configured that is capable of being surface-mounted on a substrate.

1. An antenna comprising:
a dielectric base; and
a radiation electrode formed in the dielectric base,
a first point and a second point adjacent to each other, the first point being at a position at a first electrical length from a power feeding end of the radiation electrode, in an electrical length leading from the power feeding end to an open end of the radiation electrode, the second point being at a position at an electrical length of about ½of the first electrical length from the first point in a direction of the open end, and capacitance being formed between the first point and the second point.

2. The antenna according to claim 1, wherein
a third point and a fourth point are adjacent to each other, the third point is at a position at a second electrical length from the power feeding end of the radiation electrode, in the electrical length leading from the power feeding end to the open end of the radiation electrode, the fourth point is at a position at an electrical length of about ½of the second electrical length from the third point in the direction of the open end, and capacitance is formed between the third point and the fourth point.

3. The antenna according to claim 1, wherein
the dielectric base is a compact of a dielectric composite resin material in which a dielectric ceramic filler is distributed within a resin material.

4. A wireless communication device comprising:
the antenna according to claim 1; and a communication circuit being connected to the antenna, wherein the communication circuit is configured in a substrate, and the antenna is connected to the substrate.
